(19) United States
(12) Patent Application Publication
(10) Pub. No.: US 2002/0029202 A1
(43) Pub. Date: Mar. 7, 2002

(54) System and methods for unified routing of mailpieces and processing sender notifications

(76) Inventor: Steven W. Lopez, Orlando, FL (US)

Correspondence Address: JEFFREY S. WHITTLE, ESQUIRE, ALLEN, DYER, DOPPELT, MILBRATH & GILCHRIST, P.A., P.O. Box 3791, Orlando, FL, 32802-3791, US

(21) Appl. No.: 09/736,055

(22) Filed: Dec. 13, 2000

Related U.S. Application Data
(60) Provisional application No. 60/197,699, filed on Apr. 18, 2000.

(51) Int. Cl. G06F 17/60

(52) U.S. Cl. 705/406

(57) ABSTRACT

A system and methods for routing mailpieces undeliverable as originally addressed is provided. The system and methods generate a single scan image of address block attributes that is segmented into discrete indicators for subsequent generation of forwarding addresses and sender notifications so mailpieces are processed in a single operation. The segmented image also provides the information needed to generate sender notifications when such are requested. Mailpieces to be returned to senders are similarly processed in a single operation. Multi-page mailpieces, such as magazines and articles, which cannot be delivered but which are not worth the cost of return postage, are processed by comparing the exposed portion of the mailpieces to a set of stored images to determine who the sender is so that the sender can be notified. These various operations can be performed on the same system and for differently sized mailpieces.

### CROSS-REFERENCE TO RELATED APPLICATIONS

This application claims the benefit of Provisional Patent Application No. 60/197,699 filed Apr. 18, 2000, and titled Centralized Forwarding System and Returned to Sender Processor And Associated Methods.

### FIELD OF THE INVENTION

The present invention relates to the field of product handling and, more particularly, to mailpiece handling systems and methods.

### BACKGROUND OF THE INVENTION

Not all mailpieces can be delivered to the mail receiver indicated as addressee on the front of a mailpiece such as an envelope, circular, package or publication. Effective mailhandling, therefore, requires efficient procedures for routing mailpieces where an existing forwarding address is on file for a particular addressee and for returning mailpieces worth sending back to a known sender. In addition, a sender will often want to know whether the mail has been forwarded, and if so, to where. If a mailpiece is returned, a sender may want to know the reason why. This is especially true for the many commercial and publishing entities that send mail to repeat customers or subscription readers. In some cases, the mailpiece is not worth the postage it would cost to return the mailpiece to the sender. This is frequently the case with respect to mailpieces such as weekly magazines, catalogues, circulars, and other publications. Nonetheless, the sender of such items will frequently want to know whenever the mailpiece has not been delivered to the address the sender has on file, as well as the reason for non-delivery. Again, if the mailpiece is forwarded the sender is likely to want to be informed of the forwarding address.

Most mailhandling services have sought to accommodate the above-described demands of their customers, but conventional methods are highly labor-intensive despite attempts over the years to make better use of computers and automated processing technology. The United States Postal Service “USPS”, for example, has implemented a Centralized Forwarding System “CFS” to deal with forward mail processing. With this system, the USPS maintains records for households and individuals that have moved to a new address, maintaining each individual record for approximately a year, stored in an old-new address database. The database is accessed by an operator, using a keyboard and display terminal, who enters an “extraction code” (i.e., the first four characters of a last name and the last three numbers of a street address). If a match is made with a new forwarding address, a label is printed and applied to the mailpiece, usually having a barcode to facilitate subsequent processing.

The USPS has also implemented an Address Change Service (“ACS”) that allows mailers to place a sender notification request, in the form of a USPS-approved barcode, signaling the sender's desire to be informed of the forwarding address if a mailpiece is forwardly routed. Traditionally, informing a sender about a forwarding address has been done by the USPS through “3547” processing, named for the form with which a sender requests the notification. The USPS also has traditionally performed return-to-sender (“RTS”) processing wherein letters not delivered, but not otherwise suitable for forwarding, are returned to the sender. RTS processing is conventionally carried out in stages, firstly with the mail carrier manually marking the mailpiece to indicate a reason for return and, secondly, returning the mailpiece to the post office where it can be re-mailed to the sender at the address that appears at the upper left front portion or on the backside of the mailpiece. At some offices, RTS mailpieces are processed at a USPS facility on a cancellation device that marks the mailpiece with an indicator of one of eight reasons why the mailpiece is being returned.

For those mailpieces not worth the cost of return postage, the USPS has utilized “3579” processing, named after another USPS form requesting notification if a mailpiece is not forwarded for some reason but not returned. Such mailpieces are generally weekly periodicals or other bound multi-page mailpieces. With conventional “3579” processing, the USPS removes the exposed page of the mailpiece and returns it to the sender for a postage fee.

These traditional methods utilized by the USPS and similar ones employed by other mailhandling services, as noted, are highly labor-intensive notwithstanding persistent attempts to improve processing efficiency through automation. The USPS's CFS processing, as noted, requires a keyboard operator to enter data in search of a corresponding forwarding address. The USPS is in the process of developing a Postal Address Redirection System “PARS” whereby mailpieces can be read with a multiline optical character reader “MLOCR” to direct mailpieces to a forward destination, but it is as yet unknown how effective PARS is likely to be. Moreover, it is doubtful that the proposed system will process with equal facility intermixed mailpieces composed of letters and flat mail. The USPS defines letters as being larger than 3″ wide×5″ long×0.007″ thick and smaller than 6.125″ wide×11.5″ long×0.25″ thick, and defines flats as larger than letters but smaller than 10″ wide×13″ long×0.75″ thick. Currently, these different sized mailpieces are processed using distinct or separate devices.

In addition, the other conventional procedures employed by the USPS and other mailhandling services remain costly in terms of time and resources. A notice to the sender of a mailpiece forward and the corresponding forwarding address using the USPS's current 3547 processing requires a clerk to photocopy the front of the mailpiece in a separate procedural operation after the manual lookup procedure for ascertaining the forwarding address has been completed and a new forwarding label has been applied to the mailpiece. So, too, the USPS's current 3579 process remains highly labor-intensive. Not only must data be entered manually by a keyboard operator at a display terminal, but after a return address is identified for a magazine cover or similar mailpiece, the cover must be torn off and labeled. The procedure is not complete until each of these torn-off covers are gathered and manually placed in individual envelopes for sending to the original sender.

### SUMMARY OF THE INVENTION

With the foregoing in mind, the system and methods of the present invention advantageously provide efficient mail processing that, as compared to existing procedures, reduces processing steps and more efficiently automates others. The system and methods provide additionally a higher level of quality and consistency for forwarding or returning mailpieces, indicating reasons for the return, and notifying customers of addressee forwards. The present invention provides a system and related methods for processing a plurality of intermixed mailpieces, including letters and flat mail, which for one reason or another are not deliverable to the receiver location address indicated on each mailpiece. Some of the mailpieces to be processed are to be forwarded to a receiver forwarding address and some are to be returned to the sender. In addition, some sender's are to be notified when a mailpiece has been forwarded and what the forwarding address is. If a mailpiece is returned, a sender is to be informed as to the reason why. Finally, some mailpieces that cannot be delivered, will not be worth the cost of return postage, but senders nonetheless will want notification of the non-delivery.

The present invention provides a single, unified system for accomplishing each of the described procedures. For each distinct procedure, the system and methods of the present invention eliminate the most labor-intensive steps found in the procedures as currently practiced, while more efficiently automating the remaining ones. These aspects are detailed below in the context of the distinct procedures currently and widely used for mailhandling. It is worth noting, however, that additional efficiencies are achieved by unifying the operations so that distinct procedures can each be effected utilizing the same system and methods according to the present invention. In addition, the system and methods perform equally well on both letter and flat mail, eliminating the cost of maintaining separate systems for processing distinctly sized mailpieces.

With respect, specifically, to mail forward processing, mailpieces are forwarded in a single operation, beginning with the electronic scan of each mailpiece so that a single-scan image is generated for each of a plurality of mailpieces. Each single-scan image is processed to segment for each mailpiece the receiver location address indicator, sender return address indicator, and ascertain whether a sender notification indicator appears on the particular mailpiece. The receiver location address indicator so imaged can be compared, preferably utilizing an optical character reader and character comparison algorithm, to a stored list of addresses constituting a database of receiver forwarding address indicators. Once the latter indicator is identified, a label is applied to the mailpiece being processed and on it is printed the forwarding address, preferably with a 3-line or more multiline printer so that the operation is completed without the particular mailpiece's ever having left the path of travel over which processing occurs.

The result, as compared to existing systems and methods, is the elimination of manual entry of address indicator data with a concomitant reduction in cost in terms of time and resources. Indeed, it is estimated that as compared to current practices up to about 60 percent of mailpieces processed can be handled without manual keyboard data entry using the system and methods of the present invention. Although the remaining approximately 40 percent will be processed utilizing operator-supplied data, the processing is achieved with sufficiently more efficiency, perhaps leading to as much as about a 26 percent increase in overall productivity.

Moreover, the single-scan image is stored for subsequent processing. If a sender notification indicator is detected on the mailpiece being processed, the forwarding address indicator can be culled from the stored single-scan image for subsequent use in generating a sender notification notifying the sender that the mailpiece has been forwarded.

Relying further on the combination of single-scan imaging and character comparison algorithms, traditional 3547 processing is similarly made significantly more efficient. A sender notification can be prepared bearing the receiver address location indicator and corresponding forwarding address indicator. The sender notification will be directed to the sender return address indicator likewise culled from the initial single-scan image generated. Again, as compared to current procedures employed by mailhandling services such as the USPS, there are significant efficiencies achieved. Notably, the laborious step of repetitive data entry is reduced. Even more significantly, the need to photocopy a labeled mailpiece to generate the sender notification, as currently done by the USPS, is entirely eliminated. Thus, with respect to this procedure, too, the present invention generates further efficiencies and concomitant cost savings.

Likewise, in place of manually sorting publications and entering data requests to identify a publisher's address in 3579 processing, relevant data groups can be culled from a single image scan of the exposed page of a publication. An image comparison between the scanned image and each of the images stored as part of a current-publications database containing cover page images and corresponding publisher addresses can then be made. When a match is achieved, a sender notification can be generated and printed. The publisher's address will be indicated on the notice generated, obviating the need as exists with current procedures for individually tearing off cover pages and manually putting them in envelopes to be addressed to a publisher once the publisher's address has been identified through manual data entry. Accordingly, even greater efficiencies over existing procedures are achieved.

In addition to allowing single operation processing of distinct procedures, the system and methods of the present invention permit processing of letters and flat mail alike. As described below in detail, the system and methods of the present invention provide a variable speed controller to determine the rate at which mailpieces are fed into the system for processing and a stacker alignment to thereby permit both letters and flat mail to be processed on the same system utilizing the same system. This further reduces costs by eliminating the need for multiple equipment or, alternatively, downtime and reconfiguration for different sized mailpieces.

### BRIEF DESCRIPTION OF THE DRAWINGS

Some of the features, advantages, and benefits of the present invention having been stated, others will become apparent as the description proceeds when taken in conjunction with the accompanying drawings in which:

FIG. 1 is a schematic block diagram of forward mail processing according to a system and methods of the present invention;

FIG. 2 is a schematic block diagram of RTS mail processing according to a system and methods of the present invention;

FIG. 3 is a schematic block diagram of second pass RTS mail processing according to a system, apparatus and methods of the present invention;

FIG. 4 is a schematic block diagram of “3547” mail processing according to a system and methods of the present invention;

FIG. 5 is a schematic block diagram of offline mail processing according to a system and methods of the present invention;

FIG. 6 is a schematic block diagram of “3579” mail processing according to a system and methods of the present invention;

FIG. 7 is a top plan of a typical letter mailpiece having a return label, stamp, address label, and postnet bar-code positioned thereon according to the present invention;

FIG. 8 is a top plan of a letter mailpiece having a reason-for-return indicator positioned thereon according to the present invention;

FIG. 9 is a top plan of a letter mailpiece having a receiver forwarding address indicator positioned thereon according to the present invention;

FIG. 10 is a top plan of a 3547 processing sender notification mailpiece according to the present invention;

FIG. 11 is a schematic view of a mailhandling system, including process controller and associated processing elements, according to the present invention;

FIG. 12 is a top plan of a mailhandling system according to the present invention

FIG. 13 is a side elevational view of a reverse image processor according to the present invention;

FIG. 14 is an elevational view of a scanned image of the front side of a letter mailpiece along with a superimposed image of a reverse-sided sender return address indicator according to the present invention;

FIG. 15 is a fragmentary perspective view of a mailhandling system having a reverse image processor according to the present invention;

FIG. 16 is an elevational view of a scanned image of the front side of a letter mailpiece along with a superimposed image of a reverse-sided sender return address, and the corresponding image after it has been properly realigned by reverse image processing according to the present invention.

### DETAILED DESCRIPTION OF THE PREFERRED EMBODIMENTS

The present invention will now be described more fully hereinafter with reference to the accompanying drawings which illustrate preferred embodiments of the invention. This invention, however, may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. The prime notation, if used, indicates similar elements in alternative embodiments.

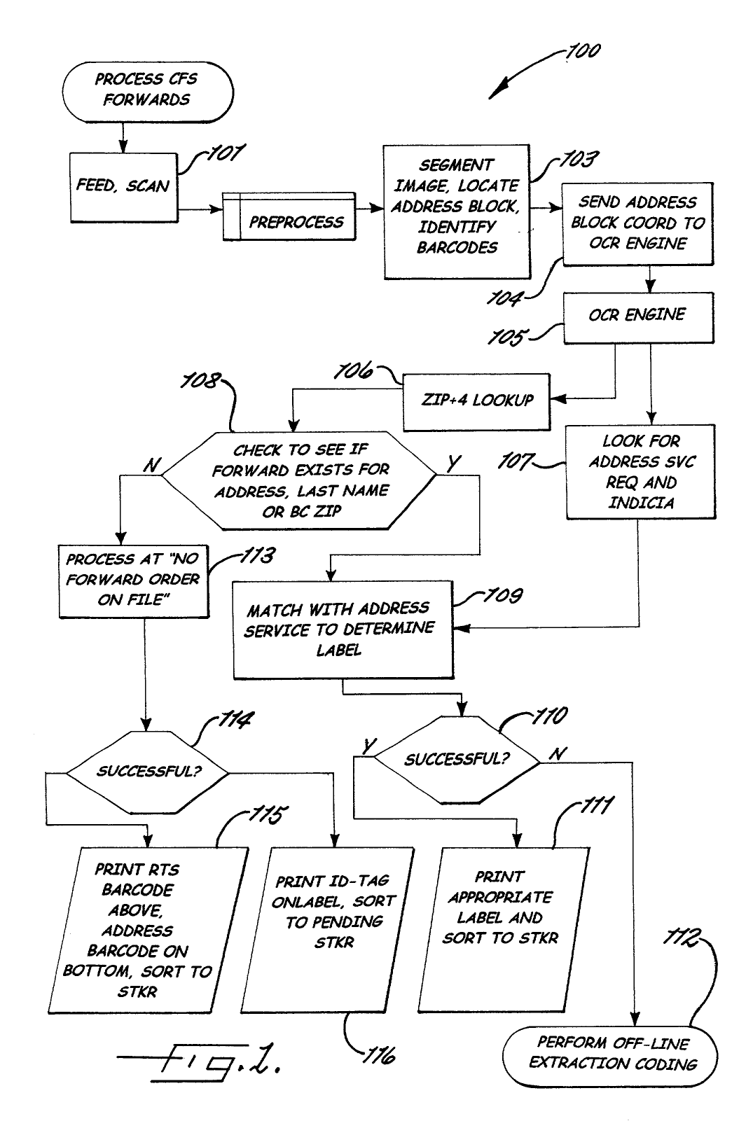

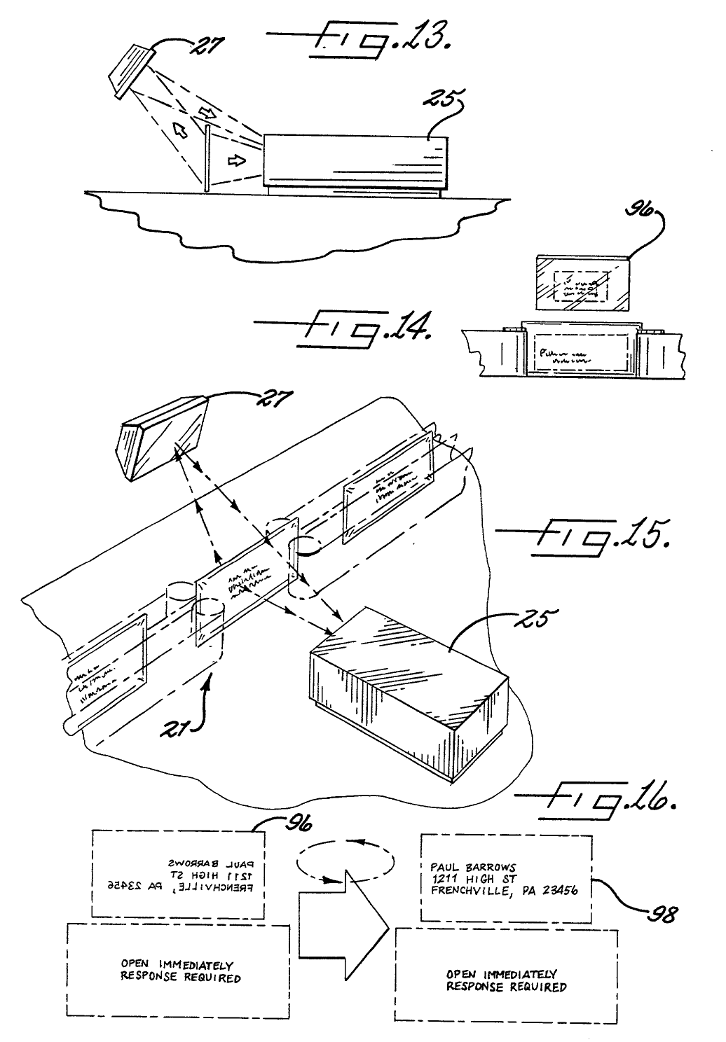

FIGS. 1-6 and 11-16 illustrate a system 10 and related methods 100, 200, 300, 400, 500, 600 for processing a plurality of mailpieces which for one reason or another are not deliverable to the receiver location address indicated on each mailpiece. Some of the mailpieces to be processed are to be forwarded to a receiver forwarding address and some are to be returned to the sender. Some sender's will desire to be notified of the forwarding address when a mailpiece has been forwarded. If a mailpiece is returned, a sender is to be informed as to the reason why. Additionally, for some mailpieces that cannot be delivered but are not worth the cost of return postage, the senders nonetheless will want notification of the non-delivery.

The present invention provides a single, unified system for accomplishing each of these procedures. More specifically, the system and methods of the present invention reduce processing steps and more efficiently accomplish others as compared to conventional procedures. The system and methods described herein, moreover, facilitate linking one or more destination printers via a communications network so that mailpieces can be processed at one location and corresponding labels printed at any of a number of remote sites by networked destination printers. Substantial efficiencies are generated by unifying and linking via a network the various operations related to mail routing and processing sender notification. Moreover, efficiencies are enhanced in so that distinct procedures can be effected utilizing the same system. In addition, the system and methods perform equally well on both letter and flat mail, eliminating the cost of maintaining separate systems for processing distinctly sized mailpieces.

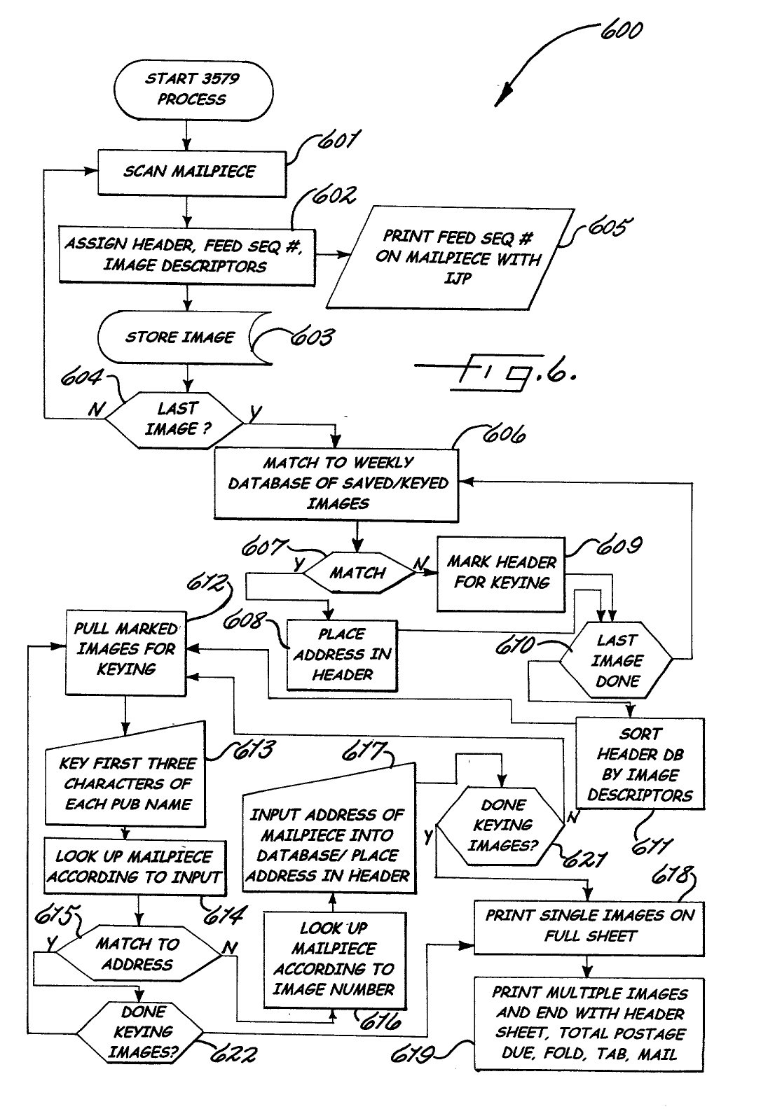

The system 10 preferably includes a mailpiece feeder 11 that individually feeds a plurality of intermixed mailpieces. Each of the plurality of intermixed mailpieces has separate receiver location address indicators 62, sender return address indicators 72, and sender notification indicators 74 positioned thereon (see FIGS. 7-10 and 12). The system 10 also includes a mailpiece transporter 20 in position to receive from the mailpiece feeder 11 each of the plurality of mailpieces and transport each therefrom along a predetermined path of travel 21. The system 10 further includes a mailpiece scanner 25 placed downstream from the mailpiece feeder 11 and adjacent the mailpiece transporter 20 along the path of travel 21 of the plurality of mailpieces to scan the separate receiver location address indicators 62, sender return address indicators 72, and sender notification indicators 74 of each of the plurality of intermixed mailpieces to thereby create a single-scan image of address indicators and notification indicator data for each corresponding mailpiece (FIGS. 7-9). As described more fully below, the single-scan image is generated by an optical character reader, digital camera or other comparable device in order to image address and notification data (i.e., receiver location address indicator 62, sender return address indicator 72, and any sender notification indicator 74) and capture the data electronically as the mailpiece traverses the path of travel 21 in a single pass. The image so generated, moreover, is processed so as to describe the address block attributes “ABA” of each corresponding mailpiece. The resulting ABA provides in the form of digitized code a representation of mailpiece attributes, including the physical aspects of the mailpiece and its address area, thereby serving as a type of mailpiece “fingerprint” that can be stored, sorted, and retrieved in subsequent processing steps.

A mailpiece labeler 28 in this embodiment of the system 10 is also positioned downstream from the mailpiece scanner 25 and adjacent the mailpiece transporter 20 along the path of travel 21 of the plurality of mailpieces in order to label each of the plurality of mailpieces with a preselected routing indicator.

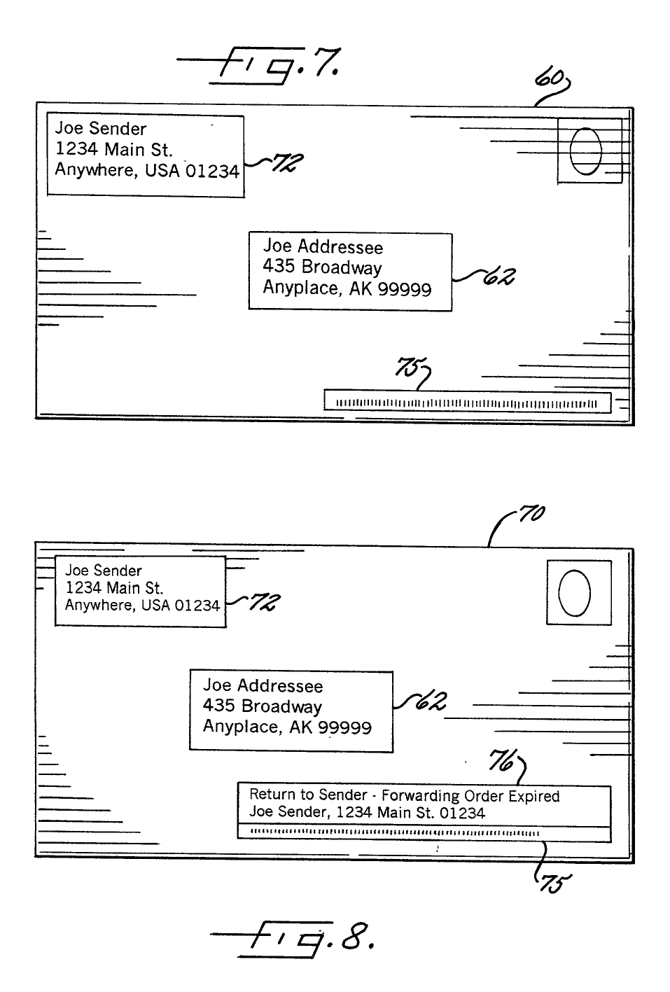

The embodiment moreover further includes a process controller 16 in communication with the mailpiece scanner 25 and mailpiece labeler 28 to receive the single-scan image, separate the image into discrete data groups of at least address indicators 62, 72 and sender notification indicator 74, instruct the labeler 28 to label each of the plurality of mailpieces with a preselected routing indicator 84, and generate a sender notice 90 when desired (see FIGS. 10-12). The process controller 16 includes a forwarding address determiner 17 responsive to the receiver location address indicator 62 data group of each of the plurality of mailpieces to determine when the receiver address location indicator 62 of a corresponding mailpiece corresponds to one of a predetermined list of forwarding addresses and thereby instruct the labeler 28 to label the mailpiece with the corresponding forwarding address indicator 84 (see FIG. 9). The predetermined list of forwarding addresses is preferably a database 701 of forwarding address indicators in communication with the forwarding address determiner 17 of the process controller 16.

The process controller 16, moreover, includes a return-to-sender determiner 18 responsive to the sender return address indicator 72 data group of each of the plurality of mailpieces to determine when a corresponding mailpiece is to be returned to sender and thereby instruct the labeler 28 to label the mailpiece with the corresponding return address indicator 76.

Also included as part of the process controller 16, is a sender notification determiner 19 responsive to the sender notification indicator 74 data group of each of the plurality of mailpieces to determine when to generate a sender notice 90.

This embodiment of the system 10 can also include a mailpiece stacker 30 that is positioned downstream from the mailpiece transporter 20 to receive each of the plurality of the intermixed mailpieces from the mailpiece transporter 20 and to direct each of the mailpieces to one of a plurality of preselected stacking positions according to whether the particular mailpiece is to be returned to a mailcarrier for delivery or be subjected to additional processing.

As already noted, the system 10 preferably scans mailpieces electronically using an optical character reader or similar device in order to generate a single-scan image of the address and notification data 62, 72, 74 and capture the data electronically as the mailpiece makes a single pass along the path of travel 21 of the mailpiece transporter 20. With the data thus captured, software techniques as understood by those skilled in the art can easily segment the data so as to isolate for distinct processing purposes the receiver location address indicator 62, sender return address indicator 72, and any sender notification indicator 74. Having captured and segmented the data, the processor 16, for example, can utilize character comparison techniques to search for a match between the receiver location address indicators and receiver forwarding address indicators using a character image matching algorithm. The single scan image is used to generate a label that is then applied to a mailpiece. Thus, rather than processing in multiple steps requiring manual data entry, mailpieces are scanned, an image generated, and a label having the forwarding address indicator 84 thereon is applied to the mailpiece so that each mailpiece is processed in one complete cycle of system 10 operation.

Mailpieces to be returned to sender can similarly be processed in one cycle with each mailpiece that is to be returned being completely processed as it traverses the path of travel 21 only once without any of the plurality of mailpieces leaving the path of travel 21 along which processing occurs. The system and methods of the present invention process mailpieces to be returned to sender by comparing the receiver location address indicator with a stored list of addresses for which no forwarding address has been filed. For each stored address there preferably is also stored a corresponding reason-for-return indicator. Preferably, the addresses and corresponding reason-for-return indicators are stored as a database 702 in communication with the return-to-sender determiner 18 of the process controller. If a match is made, the mailpiece is labeled for return to sender and marked with the reason for return, as described more fully below. Otherwise, the address and reason-for-return are entered into the database 702, as for example, by a key punch operator at a video display terminal and keyboard 97, and stored for subsequent mailpiece processing. In either event, the mailpiece receives a label containing the sender's return address indicator 72 and a reason for the mailpiece's return. This contrasts, the conventional systems and procedures used by mailhandling services such as the USPS whose forwarding procedures have relied exclusively on manual entry of data indicators by keypunch operators using video display terminals.

FIG. 1 illustrates, in perhaps greater detail, the method 100 of the present invention that can also be implemented by the system 10 for processing mail for forward routing. The method 100 is initiated by feeding mailpieces for scanning (Block 101) to generate a single-scan image of the receiver location address indicator 62 and any other indicators, such as barcodes, that may be positioned on a mailpiece undergoing processing. The single-scan image is segmented so that the individual address blocks having receiver location address indicators 62 and sender return address indicators 72 are separably identified along with any barcodes or other indicators that may appear on the same mailpiece (Block 103). In the subsequent step (Block 104), the address block with address indicators 62, 72 is processed, preferably utilizing an optical character reader (“OCR”) as well understood by those skilled in the art. The OCR engine (Block 105) compares the receiver location address indicator 62 with a preexisting set of forwarding addresses to determine whether the mailpiece is to be forwarded. In the context of United States mail handling, the determination made by the system 10 and related method 100 can be facilitated by using the standard USPS “ZIP+4 Lookup” system (Block 106). The OCR engine also searches the segmented image for a sender notification indicator 74, such as an address correction request on a mailpiece (Block 107). Again, in the context of domestic United States mail handling, the USPS has instituted the Address Change Service (“ACS”) whereby a mailer may include on the mailpiece a USPS-approved message above the receiver location address requesting the service to notify the mailer when a mailpiece is forwarded (See USPS Publication 8, at pages 9-13). Thus, consistent with the ACS, the system 10 and method 100 not only determine whether a forwarding address match exists (Block 108), but also ascertain whether a sender notification 90 should be generated (Block 109) according to whether a sender notification indicator 74 was present on the mailpiece being processed.

If a successful match is obtained (Block 110), a label is applied to the mailpiece, and on it is printed a receiver forwarding address indicator 84 so that the mailpiece can be appropriately forwarded. Preferably, the system 10 will include as part of the labeler an ink jet printer 29 or other printing device as understood by those skilled in the art, having the capability to print at least three discrete lines simultaneously so as to permit the appropriate forwarding address indicator 84 data to be printed on the label (Block 111) as the mailpiece travels once past the printer on the mailpiece transporter 20. Coupled with the ability to scan (Block 101), segment the single-scan image (Block 103), and determine a forwarding address match (Block 108), the system 10 allows the mailpiece to be completely processed on a single pass without the mailpiece leaving the path of travel 21 of the mailpiece transporter 20. This contrasts with conventional systems and methods which require manual keypunch entry of data in separate, additional processing steps, leading to higher costs and slower forward mail processing.

If it is determined that there is no match (Block 108) because there is no forwarding order with address on file, or for any other reason such as an incorrect address or no such addressee at the address, then the mailpiece is processed (Block 113) as not having a forwarding address on file and a determination is made whether the mailpiece is to be processed for a return to sender (Block 114). If so, the mailpiece is then submitted for return-to-sender (RTS) processing (Block 115). Preferably, as part of RTS processing, the mailpiece is labeled below the sender return address indicator with an indicator such as a barcode corresponding to the receiver location address indicator. The mailpiece is also labeled above the sender return address indicator with a barcode corresponding to the sender return address indicator 72. In accordance with this specific embodiment of the present invention, the mailpiece can be returned to a mailcarrier to attempt a second-time delivery of the mailpiece. If delivery is again unsuccessful, the mailcarrier simply marks out the bottom barcode and the mailpiece is returned for subsequent RTS processing, as described below.

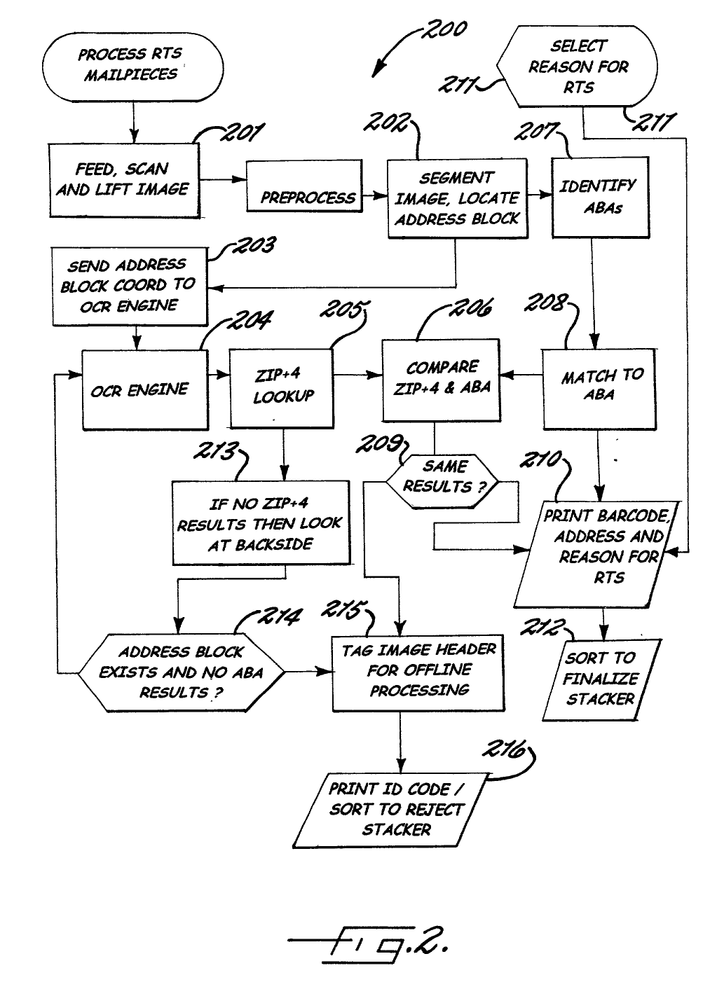

FIG. 2 illustrates RTS processing, describing the method steps 200 of the present invention that also can be implemented by the system 10 for handling mailpieces to be returned to sender. These method steps can be carried out as a continuing part of the forward mail processing 100 as substantially described above or as an independent processing operation. The initial step of the procedure 200 is to individually scan each of a plurality of mailpieces so as to generate a single-scan image (Block 201) of address indicators. The single scan image is segmented into address blocks (Block 202) and the ABAs identified (Block 207). The address block is compared (Block 203), preferably using an OCR engine (Block 204), to determine a match between the address block indicator such as the USPS's “ZIP” 4 and the ABA (Block 206). If a match is obtained (Block 209), a label will be applied to the mailpiece, as already described, on which will be printed the sender return address indicator along with an indicator of the reason for returning the mailpiece to the sender (Block 210). The mailcarrier will have originally determined the reason for non-delivery, which can be independently indicated (Block 211). With the procedure 200, mailpieces can be processed as a batch having all mailpieces to be returned for the same reason. In addition, however, the system 10 and method 200 permit storage of address indicators specifying for each mailpiece addressed to a specific addressee the reason for return. In any event, the system 10 and method 200 will label the mailpiece and print the sender return address indicator and reason for return as described above (Block 210).

FIG. 2 further illustrates that for any mailpiece for which a sender return address indicator 72 is not found in the single-scan image of the front side of the mailpiece, the opposing side of the mailpiece will also have been scanned in order to image any address indicator positioned there (Block 213). If the sender return address indicator 72 is found on the reverse side of the mailpiece, the processing proceeds as already described and culminates in the mailpiece being labeled and the appropriate address indicator and reason for return printed thereon (Block 212). If no address indicator is found on either side of the mailpiece, the mailpiece is nonetheless tagged or labeled (Block 215). An identifying code indicator, preferably a barcode, is printed on the tagged or labeled mailpiece for use in subsequent processing, and the mailpiece is sorted for subsequent processing (Block 216).

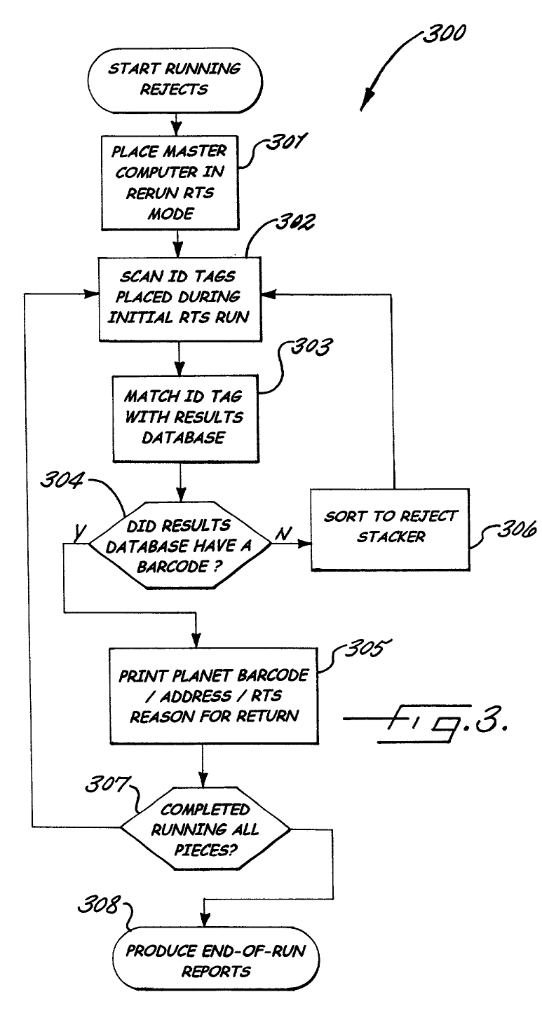

FIG. 3 illustrates the subsequent RTS second pass processing procedure 300. The procedure 300 is preferably implemented on a system utilizing a processor 16 that is a programmable computer which can be programmed for additional RTS processing. This permits the system 10 as described above to implement the steps 300 utilizing the same system devices. More specifically, the process controller is placed in rerun RTS mode (Block 301). The identifying code indicators applied to each mailpiece during the preceding RTS processing are scanned (Block 302). The scanned image is compared with a set of images stored in a database to determine whether a corresponding address and reason for no deliver at such address (Block 303). If so (Block 304), a label is applied to the mailpiece and on the label is printed a return to sender address indicator 76 along with the reason for return as determined by the comparison with the database images. If no match is made (Block 304), the mailpiece is sorted to a reject stacker for additional processing or disposal (Block 306). If the entire plurality of mailpieces has been processed (Block 307), then the procedure concludes with an end report being generated (Block 308).

The RTS procedure 200 and second pass RTS procedure 300 as implemented by the present invention contrast with conventional procedures such as are employed by the USPS. Conventional procedures require manual notation on each mailpiece by the individual mailcarrier as to the reason for no delivery; to the degree equipment is employed by USPS in carrying out this procedure at some facilities, it has been to run mailpieces through a cancellation device that applies a notation indicating one of eight reasons for non-delivery of a mailpiece. The RTS procedure 200 and second pass procedure 300 of the present invention, however, utilize scan-generated images and character comparison algorithms that allow for creation of a single-scan image of a receiver location address indicator 62 that can be stored and correlated with an indicator for non-delivery. Having a stored location address indicator 62 that can be matched using a processor to a corresponding reason for no delivery indicator eliminates manual processing and allows for automated generation of a label bearing an indication of the reason for no delivery as well as the sender return address indicator 72.

FIG. 4 illustrates a 3547 processing procedure 400 according to the present invention. The 3547 procedure, as already noted, is intended to generate a notice to the sender when a mailpiece is forwarded informing the sender of the forwarding address. As already described in the context of forward mail routing, and as further illustrated in FIG. 4, each of a plurality of mailpieces utilizing the present invention is scanned (Block 401), and single-scan images of receiver location address indicators and sender return address indicators appearing on each of a plurality of mailpieces is generated. The images are stored for subsequent processing (Block 402). The receiver location address indicator 62 and sender return address indicator 72 are identified for each single-scan image (Block 403) As described above, a match is sought for each mailpiece between the receiver address location indicator 62 and a receiver forwarding address indicator 84 (Block 404), preferably using an OCR engine and character recognition algorithms for comparison of the receiver location address indicator with a list of possible return addresses from a database of addresses 701. If no match is made, the mailpiece is flagged for additional processing as earlier described (Block 405); otherwise the image is flagged for use in generating a sender notification 90. Once a determination is made that each of the plurality of mailpieces has been scanned and a comparison made (Block 406), the stored single-scan images which have been flagged for generating a sender notification 90 are sorted (Block 407).

Once sorted, the single-scan images of receiver location and forwarding address indicators, along with the sender return address indicators, are displayed in succession (Block 408). Each image in succession is superimposed into a “postage due” template frame along with a destination indicator corresponding to the sender return address indicator 72 in a manner that will facilitate subsequent application on a separate mailpiece. In one embodiment, the destination indicator will be a barcode positioned in the lower right corner of the template frame. In subsequent processing, it is determined whether the barcode corresponds to a stored return address indicator or must be supplied by a keypunch operator (Block 409). When each of the sorted images has been thus processed (Block 410), the template frames are sorted, for example, according to the USPS “ZIP+4” system (Block 411), sized appropriately for placing on a sender notification 90 of a predetermined sized (Block 412), and printed on a separate sender notification 90 mailpiece (Block 413). In a preferred embodiment, flat size mailpieces will use a full 8.5″×11″ page (Block 414) while letter size mailpieces will be printed with two images per page (Block 415) on a printer having an automatic page cutter.

Once the sorted images have been processed, sized, and framed for placement on a sender notification 90 of a predetermined size as just described, the image can be sent to any destination for printing a corresponding sender notification 90 mailpiece label. Preferably, the system 10 thus includes one or more remote site printers 800 for performing destination printing. Each destination printer, moreover, is linked to the system processor 16 via a local area network (LAN), the Internet, or any other localized or global communications network as well understood by those skilled in the art.

The 3547 procedure 400 effected by the present invention represents a considerable improvement over conventional procedures. Conventional 3547 mail processing carried out, for example, by the UPS whereby the sender has requested that if a mailpiece is forwarded to a new address, the sender be notified of the forwarding address, requires the additional manual step of photocopying the front of the mailpiece showing the forwarding address, imposing a considerable burden in terms of time and expense in contrast to procedure effected by the present invention. The manual data entry and extremely laborious step of making multiple photocopies is eliminated by the present invention, effecting a considerable savings in terms of time and mailhandling resources.

As noted above, the USPS defines letters as being larger than 3″ wide×5″ long ×0.007″ thick and smaller than 6.125″ wide×11.5″ long×0.25″ thick, and flats as larger than letters but smaller than 10″ wide×13″ long×0.75″ thick. In the present context, it is worth noting that sender notification or other address service request indicators, such as the ACS barcode indicator described above, are difficult to detect. But with the present system and methods, an image is generated before the return label is applied. Therefore, the label can be superimposed on a flat in the lower right corner of the mailpiece, and as necessary, the images can be verified even with high speed processing, as well as with manual or visual inspection, to ensure that the superimposed label does not cover the original address.

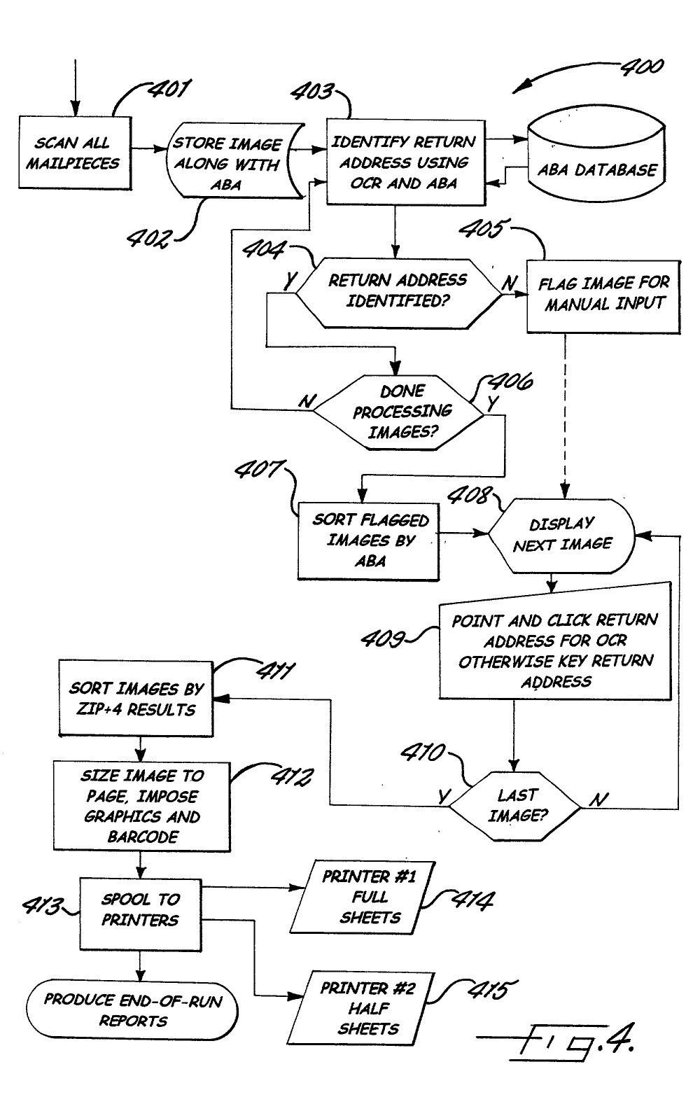

FIG. 5 illustrates the corresponding steps for processing off-line those mailpieces flagged for subsequent processing, according to the procedures described above. These will be images of address indicators for mailpieces which were to be forwarded and the sender notified, but for which no return address was obtained. Initially, the single-scan images generated in earlier processing are again sorted (Block 501) and presented, preferably to a keyboard operator at a video display terminal, each in succession (Block 502). If the image is a repeat of an earlier one presented in the succession of images (Block 503), the operator assigns the preceding return address (Block 504); otherwise the operator attempts to identify on the image a corresponding sender return address indicator, in which case the operator preferably will be able to “point and click” on the indicator (Block 505), as that procedure is understood by those familiar with the relevant art. If the indicator corresponds to a correct sender return address indicator (Block 507), the operator will proceed to the next image if any remain for processing (Block 508). Alternatively, if no correct identification is made, the operator will manually input address information for search using an extraction algorithm (Block 509) against a corresponding list of address indicators, such as the USPS “ZIP+4”.

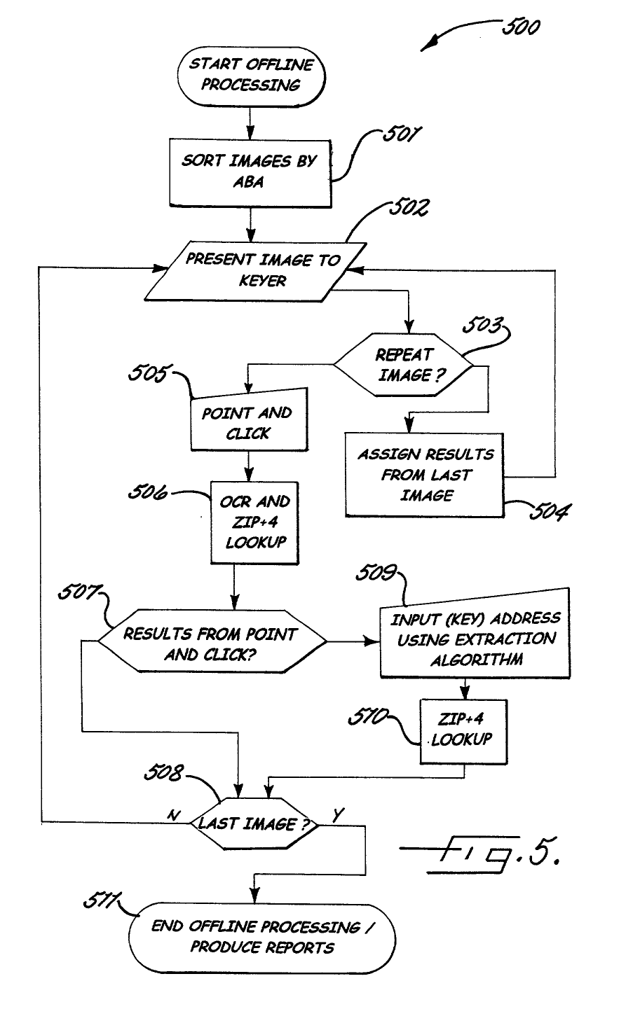

FIG. 6 illustrates yet another procedure, 3579 processing, that can be effected by the system and methods of the present invention. Such procedure is intended to notify a sender when a mailpiece could not be delivered, but where the mailpiece itself is not sufficiently valuable to warrant the cost of return postage. The procedure corresponds to and improves upon current mailhandling practices such as the current USPS 3579 processing of second class mail, primarily magazine publications. The USPS procedure requires the mailpieces be sorted and data be entered manually by a keypunch operator to identify a sender notification destination indicator. With respect to magazine publications, the USPS procedure requires that the cover page of the magazine having the receiver location address indicator 62 on it, be torn off and placed in an envelope to be sent to the publisher once the publisher's return address is identified. Thus, with current USPS procedures, 3579 processing entails numerous manual steps including looking up return addresses corresponding to a publication, preparing the return cover sheet, placing it in an envelope and appropriately labeling the envelope with the magazine publisher's address.

The present invention as illustrated in FIG. 6 achieves the same results in a substantially more efficient manner. In the present invention, a database of images corresponding to current publication cover sheets is maintained. Each mailpiece is processed substantially as described in the earlier procedures (as described below, a specific embodiment provides for an apparatus that permits online processing of bound multiple-page mailpieces such as magazines); that is, an exposed page of each multi-page mailpieces is initially scanned (Block 601). Next, an image indicator is assigned along with an image header (Block 602), and the image number is printed on the exposed page (Block 605), preferably in the lower right corner of the page, and the image and indicator are stored (Block 603). Once each of the plurality of multi-page mailpieces have thus been scanned (Block 604), each stored image is compared with a set of current publication images (Block 606). If a match is made (Block 607), the publisher's address corresponding to the matched database image is placed in the scanned image header (Block 608); otherwise the scanned image is marked for subsequent processing (Block 609).

Once all scanned images have thus been processed (Block 610), the images are sorted (Block 611), preferably by arranging the header in accordance with the image indicator. Those images for which no return address has been identified through an initial match and which have been marked for subsequent processing, are pulled (Block 612) and sorted according to pattern criteria. They are then displayed in succession to an operator, preferably positioned at a keyboard and video display terminal. For each image thus displayed, the operator will provide a shortened extraction code (Block 613) representing the publication name, which is then compared against an existing database of publication names and addresses (Block 614). Because the images have already been sorted according to pattern criteria, the operator can simply use a repeat key for subsequent identically patterned images once a determination has been made. When a match is made (Block 615), the image will be flagged with the corresponding address and put it in the printing buffer. Otherwise, the operator must pull the magazine based on the image number printed on the front, find the publication address (Block 616) and input the address where it will be included in the database of publication names and addresses. The mailpiece then will be included in the printing buffer.

After an address indicator has been determined for each image, a printing procedure commences. Mailpieces are sorted according to the destination address and volume of multiple images. The mailpiece is printed within a “postage due” frame 92 that includes a sender return address indicator and other indicator, preferably a postnet or planet barcode, 94 corresponding to the sender's address (Block 618) (see FIG. 10). Multiple images being sent to the same address will print at the end with a cover sheet indicating the total postage due, the publication address, and any corresponding postnet or planet barcode (Block 619). All the images and corresponding cover sheets are folded and either tabbed or stapled closed before sending to the publisher or other multi-page mailpiece sender. Thus, 3579 processing 600 according to the present invention represents a significant advance over conventional 3579 processing, such as carried out the USPS, in which publisher addresses are continually looked up manually and cover pages are separated and individually placed in envelopes to be addressed to the respective magazine publishers.

Even greater efficiencies are achieved by utilizing the networked destination printing described above in the context of 3547 processing. In the context of 3579 processing, images and address indicators are, again, sized and framed for placement on a notification mailpiece of a predetermined size. The images, also again, can be forwarded to any one of a plurality of printers 800 at remote sites for printing to a label on the corresponding sender notification mailpiece, wherein each destination printer is linked to the system process 16 via a local area network (LAN), the Internet, or any other localized or global communications network.

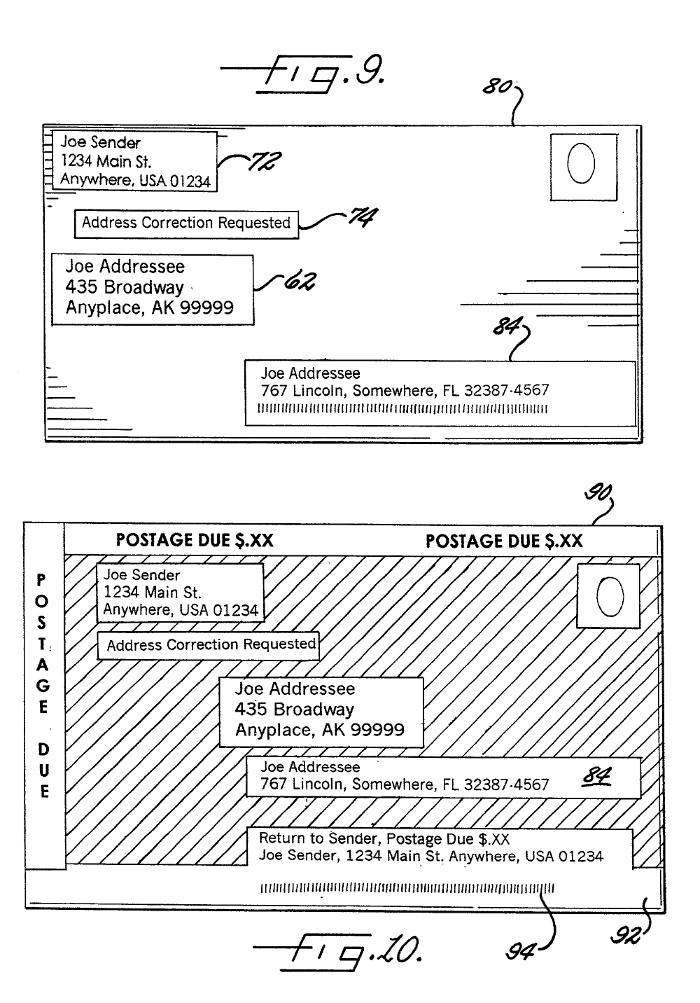

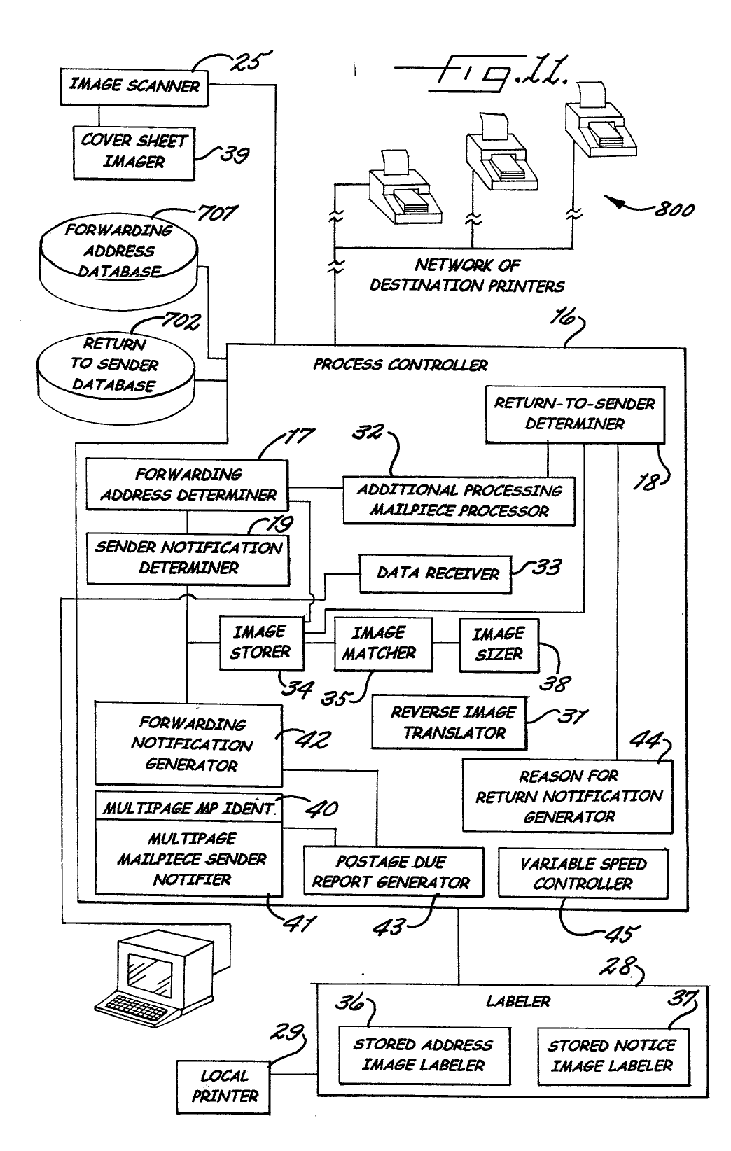

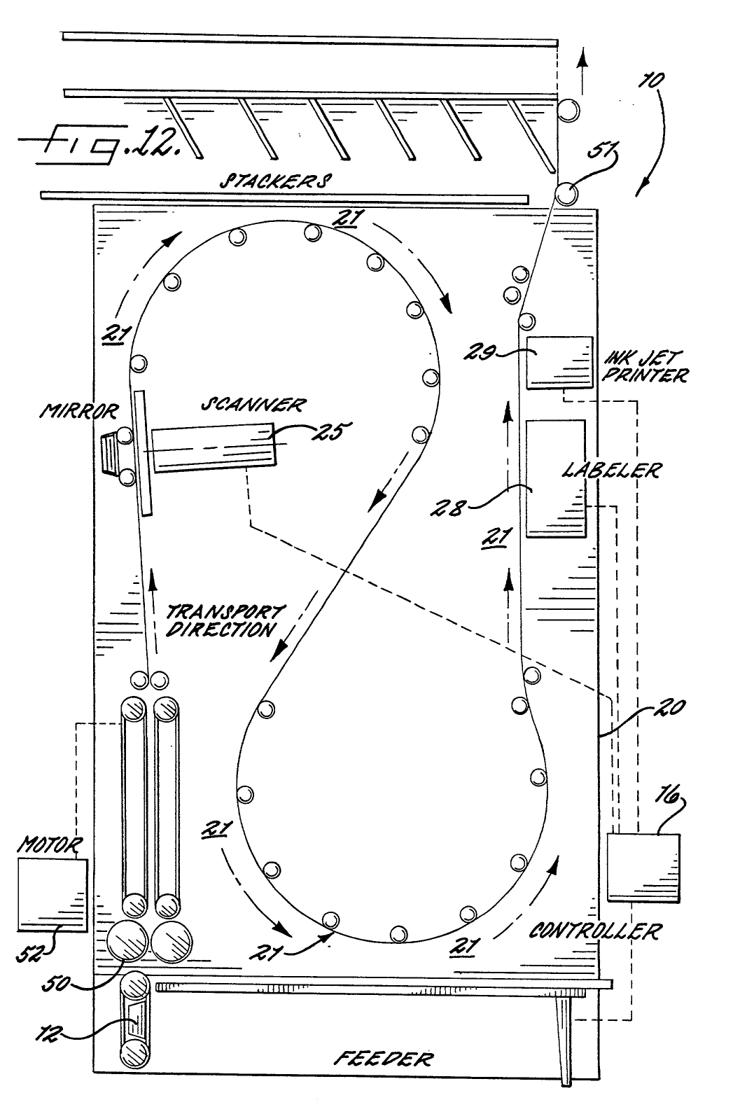

FIGS. 11-12 illustrate the preferred elements of the system 10 according to the present invention. In addition to the mailpiece feeder 11, mailpiece transporter 20, mailpiece labeler 28, mailpiece stacker 30, and process controller 16 having forwarding address determiner 17, return-to-sender determiner 18, and sender notification determiner 19, the system 10 also includes a reverse side imager 27 to image a sender return address indicator 72 positioned on a reverse side of a mailpiece. As illustrated in greater detail in FIGS. 13-16, the reverse side imager 27 interposes a sender return address indicator 72 image 96 into the single-scan image of the receiver location address indicator 62 and sender notification indicator 74 positioned on the front side of each of the plurality of intermixed mailpieces created by the mailpiece scanner, to thereby create a single data block image comprising receiver location address indicator 62, sender return address indicator 72, and sender notification indicator data 74 (FIG. 14). Preferably, the reverse side imager 27 is a mirror or mirrors positioned along side the mailpiece transporter 20, so as to efficiently reflect a mirror image 96 of a return address indicator 72 positioned on a reverse side a mailpiece. In addition, the process controller 16 preferably includes a reverse image translator 31 to re-orient the reflected mirror images, so that the mirrored image 96 is reversed so that a resulting image 98 corresponds substantially to the return address indicator 72 as it appears positioned on the mailpiece (FIG. 16).

As further illustrated in FIG. 11, the process controller 16 preferably also includes an additional processing mailpiece processor 32 to detect which mailpieces require additional processing and to instruct the labeler 28 to label each mailpiece requiring additional, or second pass, processing before mail routing with a second pass processing indicator uniquely identifying the corresponding mailpiece for subsequent additional processing. The process controller 16 preferably includes, as well, a data receiver 33 positioned to receive and store system-user-supplied data for each mailpiece which has the unique second pass processing indicator. The relevant data, usually providing a better indication of receiver's or sender's address, is supplied to the data receiver 33 by a user remote from the system 10. During second pass processing, each mailpiece is uniquely identified by its second pass processing indicator and, in response, the mailpiece labeler labels the mailpieces with the system-user-supplied data corresponding to that mailpiece's unique second pass processing indicator.

Preferably, the process controller further includes an image storer 34 and an image matcher 35 responsive to the user-supplied data to match stored images to a corresponding mailpiece. The labeler 28 of the system 10 preferably also includes a stored address image labeler 36, the labeler being in communication with the process controller 16 and positioned to label a mailpiece with a stored image of a return address indicator 72. In addition, the labeler 28 includes a stored notice image labeler 37, as well, to label a preselected mailpiece with a stored image of a sender notice 90 (see FIG. 10).

In order to process both letters and flat mail on the same system 10, the rate at which mailpieces are fed onto the path of travel 21 of the mailpiece transporter 20 preferably is variable. The mailpiece transporter preferably includes a variable speed controller 45 which determines the number of mailpieces processed per minute by speeding up or slowing down the number fed into the system, thereby increasing or decreasing the gap between successive mailpieces undergoing processing (FIG. 11). Other techniques for accommodating differently sized mailpieces on the same system, for example by varying the speed of conveyance of mailpieces by the transporter 20, will be apparent to those skilled in the art. Moreover, the system 10 will provide size-adjustable stackers to permit operating the same system on mailpieces ranging in size from substantially 3″ wide×13″ long×0.75″ thick, commonly defined as letter size, up to and including 10″ wide×13″ long×0.75″ thick, commonly defined as flat mail.

To accommodate margin-bound multi-page mailpieces such as magazines, the mailpiece transporter 20 includes vertical pinch belts 15, each movably mounted on a plurality of mechanically driven rollers 14 and extending substantially parallel to one another along the predetermined path of travel 21, and the feeder 11 preferably includes a vacuum assist device 12 to transport individual mailpieces. Preferably, the speed of the vertical pinch belts is at least 35 inches per second. In addition, the mailpiece scanner preferably is able to scan at least 5,000 mailpieces per hour. To effectively scan or “read” small print borne on a mailpiece, the mailpiece scanner 25 has a resolution of about 250 dots per inch (“dpi”) to scan fonts commonly used for preprinted return addresses on mailpieces.

Moreover, to ensure that single-scan images of address indicators can be converted into an image to fit on a label within a predetermined area of a specific size, the process controller preferably includes an image sizer 38 to adjust the size of a sender notice to fit completely and legibly within the parameters of a 8.5″×11″ mailpiece surface on which appears a sender address indicator 72 while permitting the borders of said mailpiece to be framed with a “postage due” notice 92 (see FIG. 10).

In order to complete a procedure during a single pass of a mailpiece around the path of travel 21, the mailpiece labeler 28 preferably includes a multiline ink jet printer 29 having at least a three-line capability to simultaneously print at least three lines so as to ensure that an address indicator and sender notice to be positioned on a mailpiece, having been scanned and labeled, are printed thereon as the mailpiece is conveyed in a single pass along the predetermined path of travel 21 by the mailpiece transporter 20.

As further illustrated in FIG. 11, the scanner preferably is in communication with a cover sheet imager 39 that can scan an exposed page of a multipage mailpiece, including magazine publications comprising a plurality of pages bound together at the pages' margins, so as to thereby create and store single-scan images of the exposed page of bound multi-page mailpieces. In addition, the process controller 16 preferably includes a multipage mailpiece sender notifier 41 to match the single-scan image of the exposed page of a multipage mailpiece with a corresponding image in a collection of images of exposed pages of preselected multipage mailpieces and to thereby identify a sender address indicator 72 corresponding to the single-scan image. The multipage mailpiece sender notifier 41 is positioned to be responsive to a match made by the multipage mailpiece sender identifier 40, so as to thereby cause the mailpiece labeler 28 to position a sender notification on the exposed page of the corresponding multipage mailpiece.

To effect notification of a sender when a mailpiece is forwarded and to inform the sender of the forwarding address, the process controller preferably includes a forwarding notification generator 42 responsive to a sender notification indicator 74 placed on a mailpiece so as to generate an image of the corresponding location address indicator 62, forwarding address indicator 84, and return address indicator 72, to thereby instruct the mailpiece labeler to label a separate mailpiece with the corresponding image of location address indicator 62, forwarding address indicator 84, and sender return address indicator and generate a sender notification mailpiece 90 to be sent to the sender indicating the forwarding address corresponding to the receiver's location address. The forwarding notification generator 42 preferably includes a postage due report generator 43 to sum the number of mailpieces to be sent to senders indicating the forwarding address corresponding to corresponding receivers' location addresses and computing the total postage due thereon. As already described, the process controller preferably includes an OCR, which, in conjunction with a character comparison algorithm, compares the single-scan image generated by the mailpiece scanner 25 with a preselected set of receiver location address indicators each having a corresponding forwarding address indicator, so as to determine the forwarding address indicator to appear on the system-labeled mailpiece to be forwarded to the address indicated by the forwarding address indicator 90. Consistent with the mail forward procedure described, the process controller 16 preferably includes reason-for-return notification generator 44 responsive to the return-to-sender determiner 18 to instruct the mailpiece labeler 28 to label a mailpiece to be returned to sender with an indicator indicating the reason for the return selected from a list of different reasons for returning the mailpiece to the sender.

FIG. 12 perhaps best illustrates an apparatus according to the present invention for performing each of the above-described mail handling procedures 100, 200, 300, 400, 500, 600, the apparatus preferably including a mailpiece transporter 20, which includes: a mailpiece conveyor 22 to convey each of a plurality of mailpieces along a predetermined path of travel 21; a mailpiece receiver 50 positioned upstream from the mailpiece conveyor 22 at the initial point of the path of travel 21 to receive each mailpiece for subsequent conveyance along the preselected path of travel 21; and a mailpiece dispenser 51 positioned downstream at the terminal point of the path of travel to dispense each mailpiece. The apparatus preferably includes, as well, a scanner 25, preferably an optical character reader to read data positioned on each mailpiece and generate an image of the address data. The apparatus further includes a labeler 28, such as an input-output processor and inkjet printer 29, positioned along the path of travel 21 of the mailpiece transporter 20 downstream from the labeler 28 for labeling each of the plurality of mailpieces with a preselected routing indicator. The apparatus includes a control processor 16, preferably a programmable computer, in communication with the scanner 25 and labeler 28 to receive single-scan images from the scanner 25, separate each image into discrete data groups having at least address indicators 62, 72, 84 and instruct the labeler 28 to label each of the plurality of mailpieces with the preselected routing indicator. The process controller is programmed, preferably using software procedures as well understood in the art and responsive to the location address indication data group, to determine when the receiver address of a corresponding mailpiece corresponds to one of a list of forwarding addresses forming a forwarding address database stored on the processor 16 or on a separate medium in communication with the processor 16 and to instruct the labeler 28 to label the mailpiece with the listed forwarding receiver address 84. The processor similarly is programmed to determine for mailpieces to be returned to a sender the reason why. Accordingly the processor is programmed to instruct the labeler 28 to label the mailpiece with a corresponding sender return address indicator 74 along with a reason for return indicator.

The processor 16 is also programmed to detect mailpieces requiring additional processing and to instruct the labeler 28 to label the mailpieces with reprocessing indicators identifying such mailpieces for subsequent additional processing. The processor receives supplementary data from a system user, preferably supplied by the user via a keyboard and display terminal. The user-supplied data corresponds to the data indicated as necessary by the unique reprocessing indicator needed for completing a specific mailhandling procedure.

The processor 16 also stores images or is in communication with a medium having a database for storing images of the receiver location address indicators 62, the forward-addressing-means-determined forwarding address indicator 84, and sender return address indicator 72 for subsequent processing and for generating sender notification in mail forwarding procedure 100 and addressing a reason-for-return marked mailpiece. The processor likewise is programmed to produce a postage-due report generator 43 to sum the number of mailpieces to be sent to senders indicating the forwarding address corresponding to corresponding receivers' location addresses and computing the total postage due thereon.

The processor 16 is similarly programmed to compare scanned images of receiver location address indicators 62 for mailpieces not deliverable for some reason with list of addresses stored on the processor or in a database on a separate medium in communication with the processor 16 so as to determine the return. If no corresponding address is found, additional processing is performed, but once having determined why mail is undeliverable at a specific address, the address and corresponding reason will be stored in the database. The processor, in any event, is further programmed to instruct that the labeler label a mailpiece and generate an indicator as to why the mailpiece is being returned, which is applied to the label.

The processor 16 is also programmed to store images or access a database of stored images corresponding to a collection of current periodicals, circulars, and magazines not worth returning to a sender if not delivered but for which a non-delivery notice is desired by the sender. Again, preferably using an optical character reader, the apparatus scans and images an exposed page of a mailpiece having no sender return address indicator positioned thereon, and compares the image with the stored images to determine a sender address indicator 72. The processor 16 is further programmed so that, having made such a determination, the processor instructs the labeler 28 to label a mailpiece and generate an image to be applied to the label bearing a sender return address indicator. Preferably, the processor 16 is programmed to sort the discrete images so as to process seriatim all those images to be sent to the same sender.

FIGS. 1-16 further illustrate the methods of the present invention for carrying out forward mail processing 100, RTS processing 200, second pass RTS processing 300, 3547 processing 400, offline processing 500, and 3579 processing 600. The method aspects of the present invention preferably include generating electronic images of receiver location address indicators and sender return address indicators positioned on each of a plurality of mailpieces. Moreover, the method includes determining a corresponding receiver forwarding address indicator by searching for a match between each receiver location address indicator and a corresponding receiver forwarding address indicator for each mailpiece by making an electronic comparison between the image and a preselected set of corresponding forwarding address indicators. The methods further include searching for the presence of a sender notification indicator positioned on each mailpiece. Also, the method includes generating and positioning a forwarding address indicator on each mailpiece having a match between the receiver location address indicator and the receiver forwarding address indicator. The method further includes generating and storing a sender notification for each of the plurality of mailpieces bearing a sender notification indicator, the sender notification including the receiver location address indicator, receiver forwarding address indicator, and sender return address indicator.

Additionally, the method aspects of the present invention include off-line processing, wherein address indicator data is supplied manually for each mailpiece not having a match between the receiver location address indicator and the receiver forwarding address indicator, and wherein the address indicator is subsequently positioned on the corresponding mailpiece. In addition, the methods include positioning the generated and stored sender notification on a separate mailpiece for each of the plurality of mailpieces bearing a sender notification indicator and routing the separate mailpiece to the sender return address indicator.

The method aspects corresponding RTS processing include generating electronic images of receiver location address indicators and sender return address indicators positioned on each of a plurality of mailpieces. The methods further include determining a corresponding receiver forwarding address indicator by searching for a match between each receiver location address indicator and a corresponding receiver forwarding address indicator for each mailpiece by making an electronic comparison between the image and a preselected set of corresponding forwarding address indicators. Moreover, the method includes searching for the presence of a sender notification indicator positioned on each mailpiece. The method also includes generating and positioning a forwarding address indicator on each mailpiece having a match between the receiver location address indicator and the receiver forwarding address indicator, as well as generating and storing a sender notification for each of the plurality of mailpieces having positioned thereon a sender notification indicator, the sender notification including the receiver location address indicator, receiver forwarding address indicator, and sender return address indicator.

These and other valuable uses of the present invention will come to mind for those skilled in the relevant art. Indeed, many modifications and other embodiments will come to the mind of one skilled in the art and having the benefit of the teachings present in the foregoing descriptions and the associated drawings. Therefore, it is to be understood that the invention is not to be limited to the specific embodiments disclosed herein, and that the modifications and alternative embodiments are intended to be included within the scope of the appended claims.

That which is claimed is:

1. A system for unified mail routing and sender notification of intermixed mailpieces including letters and flat mail, the system comprising:
a mailpiece feeder to individually feed a plurality of intermixed mailpieces, each of the plurality of intermixed mailpieces having separate receiver location address indicators, sender return address indicators, and sender notification indicators positioned on each mailpiece;
a mailpiece transporter positioned adjacent the mailpiece feeder to receive each of the plurality of mailpieces from the mailpiece feeder and transport each therefrom along a predetermined path of travel;
a mailpiece scanner positioned downstream from the mailpiece feeder and adjacent the mailpiece transporter along the path of travel of the plurality of mailpieces to scan the separate receiver location address indicators, sender return address indicators, and sender notification indicators of each of the plurality of intermixed mailpieces to thereby create a single-scan image of address indicators and notification indicator data for each corresponding mailpiece;
a mailpiece labeler positioned downstream from the mailpiece scanner and adjacent the mailpiece transporter along the path of travel of the plurality of mailpieces to label each of the plurality of mailpieces with a preselected routing indicator;
a process controller in communication with the mailpiece scanner and mailpiece labeler to receive the single-scan image, separate the image into discrete data groups of at least address indicators and notification indicator, instruct the labeler to label each of the plurality of mailpieces with the preselected routing indicator, and generate a sender notice when desired, the process controller comprising:
a forwarding address determiner responsive to the receiver location address indication data group of each of the plurality of mailpieces to determine when the receiver address of a corresponding mailpiece corresponds to one of a list of forwarding address indicators and thereby instruct the labeler to label the mailpiece with the corresponding forwarding address indicator,
a return-to-sender determiner responsive to the sender return address indication data group of each of the plurality of mailpieces to determine when a corresponding mailpiece is to be returned to sender and thereby instruct the labeler to label the mailpiece with the corresponding return address indicator, and
a sender notification determiner responsive to the sender notification indicator data group of each of the plurality of mailpieces to determine when to generate a sender notice; and
a mailpiece stacker positioned downstream from the mailpiece transporter to receive each of the plurality of the intermixed mailpieces from the mailpiece transporter and to direct each of the mailpieces to one of a plurality of preselected stacking positions.

2. A system as defined in claim 1 wherein the system further comprises a reverse side imager positioned to image a sender return address indicator located on a second side of each of the plurality of intermixed mailpieces and to interpose the image into the single-scan image of address and notification indicators located on the opposing side of each of the plurality of intermixed mailpieces as created by the mailpiece scanner so as to create a single data image including receiver location address indicator, sender return address indicator, and sender notification indicator data.

3. A system as defined in claim 2 wherein the reverse-side imager includes at least one mirror positioned adjacent the mailpiece transporter to thereby reflect mirror images of return address indicators located on the second side of each corresponding mailpiece to the scanner.

4. A system as defined in claim 3 wherein the process controller further comprises a reverse image translator responsive to the reverse-side imager to re-orient the reflected mirror images so that the single-scan image corresponds substantially to the return address indicator as it appears positioned on the mailpiece.

5. A system as defined in claim 4 wherein the process controller further comprises an additional processing mailpiece processor responsive to the scanner to detect which mailpieces require additional processing and to instruct the labeler to label each mailpiece requiring additional processing before mail routing with a reprocessing indicator uniquely identifying the corresponding mailpiece for subsequent additional processing.

6. A system as defined in claim 5 wherein the process controller further comprises a data receiver positioned to receive system-user-supplied data for each mailpiece having located thereon a unique reprocessing indicator and associate the received data with the unique reprocessing indicator so as to identify during a subsequent reprocessing each mailpiece having a reprocessing indicator and to instruct the mailpiece labeler responsive to the identification of the reprocessing indicator to label the mailpieces with the system-user-supplied data corresponding to the unique reprocessing indicator.

7. A system as defined in claim 6 wherein the process controller further comprises an image storer for storing images of receiver forwarding address indicators and sender return address indicators.

8. A system as defined in claim 7 wherein the mailpiece labeler includes a stored address image labeler responsive to the process controller to label a mailpiece with a stored image of a return address indicator.

9. A system as defined in claim 8 wherein the mailpiece labeler further includes a stored notice image labeler responsive to the process controller to label a mailpiece with a stored image of a sender notice.

10. A system as defined in claim 1 wherein the mailpiece transporter comprises a mailpiece conveyor driven by a fixed speed motor responsive to a mailpiece size sensor and system controller so as to feed mailpieces at rates determined by mailpiece size and to thereby process letter-sized mailpieces at a predetermined speed and flat mail-sized mailpieces at a different speed.

11. A system as defined in claim 10 wherein the size of the mailpiece stackers can be adjusted in height in response to the mailpiece size sensor to accommodate letter-sized mailpieces and flat mail-sized mailpieces so as to permit both being processing on the system.

12. A system as defined in claim 11 wherein the mailpiece transporter further comprises two vertical pinch belts each movably mounted between a plurality of spaced-apart rollers driven by the conveyor motor and extending substantially parallel to one another along the predetermined path of travel and wherein the feeder includes a vacuum assistor to assist in transporting individual mailpieces that comprise two or more separate pages bound together at their respective margins so as to define a magazine.

13. A system as defined in claim 11 wherein the vertical pinch belts is are driven by the plurality of spaced-apart rollers at a speed at least 35 inches per second.

14. A system as defined in claim 1 wherein the mailpiece scanner has a resolution of about 250 dots per inch to scan fonts commonly used for preprinted return addresses on mailpieces.

15. A system as defined in claim 1 wherein the process controller further comprises an image sizer to adjust the size of a sender notice to fit completely and legibly within the parameters of a mailpiece surface having a predetermined size and on which is located a sender address indicator along with a postage-due notice.

16. A system as defined in claim 1 wherein the mailpiece labeler includes a multiline printer positioned to selectively print either an address indicator on a label on a mailpiece or a sender notice on a mailpiece by printing simultaneously at least three lines to permit indicators and notices to be printed as a mailpiece traverses the path of travel by the mailpiece transporter in a single pass.

17. A system as defined in claim 1 wherein the scanner further comprises a cover sheet imager to scan an exposed page of a multipage mailpiece comprising a plurality of pages bound together at the page margins and to thereby create a single-scan image of the exposed page of the corresponding mailpiece.

18. A system as defined in claim 17 wherein the process controller further comprises a multipage mailpiece sender identifier to match the single-scan image of the exposed page of a multipage mailpiece with a corresponding image in a collection of images and attributes of exposed pages of preselected multipage mailpieces and to thereby identify a sender address indication corresponding to the single-scan image.

19. A system as defined in claim 18 wherein the system further comprises a multipage mailpiece sender notifier responsive to a match made by the multipage mailpiece sender identifier to thereby cause the mailpiece labeler to position a sender notification and sender address indicator on the exposed page of a corresponding multipage mailpiece.

20. A system for unified handling and routing of intermixed mailpieces including letters and flat mail, the system comprising:
a mailpiece feeder to individually feed a plurality of intermixed mailpieces, each of the plurality of intermixed mailpieces having separate receiver location address indicators and sender return address indicators positioned on each mailpiece;
a mailpiece transporter positioned adjacent the mailpiece feeder to receive each of the plurality of mailpieces from the mailpiece feeder and transport each therefrom along a predetermined path of travel;
a mailpiece scanner positioned downstream from the mailpiece feeder and adjacent the mailpiece transporter along the path of travel of the plurality of mailpieces to scan the separate receiver location address indicators and sender return address indicator of each of the plurality of intermixed mailpieces to thereby create a single-scan image of address indicators data for each corresponding mailpiece;
a mailpiece labeler positioned downstream from the mailpiece scanner and adjacent the mailpiece transporter along the path of travel of the plurality mailpieces to label each of the plurality of mailpieces with a preselected routing indicator;
a process controller in communication with the mailpiece scanner and mailpiece labeler to receive the single-scan image, separate the image into discrete data groups and instruct the labeler to label each of the plurality of mailpieces with the preselected routing indicator, the process controller comprising:
a forwarding address determiner responsive to the receiver location address indication data group of each of the plurality of mailpieces to determine when the receiver address of a corresponding mailpiece matches one of a list of receiver forwarding address indicators and thereby instruct the labeler to label the mailpiece with the corresponding receiver forwarding address indicator,
a return-to-sender determiner responsive to the sender return address indication data group of each of the plurality of mailpieces to determine when a corresponding mailpiece is to be returned to sender and thereby instruct the labeler to label the mailpiece with the corresponding return address indicator.

21. A system as defined in claim 20 wherein the process controller further comprises a forwarding notification generator responsive to a sender notification indicator positioned on a mailpiece to generate an image of the corresponding location address indicator, forwarding address indicator and return address indicator and instruct the mailpiece labeler to label a separate mailpiece with the corresponding image of location address indicator, forwarding address indicator, and sender return address indicator so as to generate a mailpiece to be sent to the sender indicating the forwarding address corresponding to the receiver location address.

22. A system as defined in claim 21 wherein the forwarding notification generator further comprises an image storer to store single-scan images generated by the mailpiece scanner comprising the location address indicator, forwarding address indicator, and return address indicator.

23. A system as defined in claim 22 wherein the forwarding notification generator further comprises an image sizer to generate images sized to fit within preselected dimensions of an area space so as to be positioned on a mailpiece having a preselected size.

24. A system as defined in claim 23 wherein the forwarding notification generator further comprises a postage due report generator for summing the number of mailpieces to be sent to senders indicating the forwarding address corresponding to corresponding receiver location addresses and computing the total postage due thereon.

25. A system as defined in claim 24 wherein the process controller includes an optical character reader to compare the single-scan image with a preselected set of receiver location address indicators each having a corresponding forwarding address indicator so as to determine the forwarding address indicator to appear on the system-labeled mailpiece to be forwarded to the address indicated by the forwarding address indicator.

26. A system as defined in claim 25 further comprising at least one remote site destination printer in communication with the process controller for printing indicia on a selected indicia carrier.

27. A system as defined in claim 26 wherein the process controller further comprises a reason-for-return notification generator responsive to the return-to-sender determiner to instruct the mailpiece labeler to label a mailpiece to be returned to sender with an indicator indicating the reason for the return selected from a list of different reasons for returning the mailpiece to the sender.

28. A system as defined in claim 27 wherein the system further comprises a reverse side imager to image a sender return address indicator positioned on a second side of each of the plurality of intermixed mailpieces and to interpose the image into the single-scan image of address and notification indicators positioned on the opposing side of each of the plurality of intermixed mailpieces as created by the mailpiece scanner so as to create a single data block image comprising receiver location address indicator, sender return address indicator, and sender notification indicator data.

29. A system as defined in claim 28 wherein the reverse side imager is a mirror positioned adjacent the mailpiece transporter to thereby reflect mirror images of return address indicators positioned on the second side of each corresponding mailpiece to the scanner.

30. A system as defined in claim 29 wherein the process controller further comprises a reverse image translator to re-orient the reflected mirror images so that the single-scan image corresponds substantially to the return address indicator as it appears positioned on the mailpiece.

31. An system for unified mail routing and sender notification of a plurality of mailpieces including letters and flat mail, the system comprising:
a mailpiece transporter comprising:
a mailpiece conveyor to convey each of the plurality of mailpieces along a predetermined path of travel,
a mailpiece receiver positioned upstream from the mailpiece conveyor and downstream from the mailpiece feeder at the initial point of the path of travel from the mailpiece feeder to receive each mailpiece for subsequent conveyance along a preselected path of travel, and
a mailpiece dispenser positioned downstream at the terminal point of the path of travel to dispense each mailpiece; imaging means positioned adjacent the
mailpiece transporter and comprising receiver location address indicator imaging means and sender return address indicator imaging means for generating single-scan electronic images of receiver location address and sender return address indicators positioned on each mailpiece;
labeling means positioned adjacent the mailpiece transporter downstream from said imaging means along the preselected path of travel for labeling each of the plurality of mailpieces with a preselected routing indicator; and
processing means in communication with the imaging and labeling means for receiving the single-scan images, separating each image into discrete data groups of at least address indicators, and instructing the labeling means to label each of the plurality of mailpieces with the preselected routing indicator, the processing means comprising:
forward addressing means responsive to the location address indication data group of each of the plurality of mailpieces for determining when the receiver address of a corresponding mailpiece corresponds to one of a list of forwarding addresses and thereby instructing the labeling means to label the mailpiece with the listed forwarding receiver address; and
return-to-sender addressing means responsive to the address indication data group of each of the plurality of mailpieces to determine when a corresponding mailpiece is to be returned to sender and thereby instructing the labeling means to label the mailpiece with a corresponding sender return address.

32. An system as defined in claim 31 wherein the processing means further comprise reprocess coding means for detecting mailpieces requiring additional processing and instructing the labeling means to label said mailpieces with reprocessing indicators identifying the said mailpieces for subsequent additional processing.

33. An system as defined in claim 32 wherein the processing means further comprises supplementary data receiving means responsive to data supplied by a system user for receiving user-supplied data and matching the data to a unique reprocessing indicator.

34. An system as defined in claim 33 wherein the processing means further comprises sender notification indicating means responsive to sender notification indicators positioned on a mailpiece for identifying a sender notification request requesting that the corresponding sender of a mailpiece be notified when the mailpiece is forwarded to an address different from that of the receiver location address indicator, generating and saving an image comprising the receiver location address indicator, the forward-addressing-means-determined forwarding address indicator, and sender return address indicator.

35. An system as defined in claim 34 further comprising sender notification generating means responsive to the sender notification indicating means for positioning the image generated by the sender notification generating means to a separate mailpiece for subsequent notification to the sender that the corresponding mailpiece is to be forwarded to the forwarding address indicator.

36. An system as defined in claim 35 further comprising image sizing means for adjusting the dimensions of the images generated by the sender notification indicating means so as to fit within preselected dimensions of a mailpiece having a preselected size.

37. An system as defined in claim 36 wherein the processing means further comprises postage-due reporting means for summing the number of mailpieces to be sent to senders indicating the forwarding address corresponding to corresponding receiver location addresses and computing the total postage due thereon.

38. An system as defined in claim 37 wherein the processing means includes optical character reading means for optically reading characters of the singles-can image and comparing the characters with a preselected set of receiver location address indicators each having a corresponding forwarding address indicator so as to determine the forwarding address indicator to appear on the corresponding mailpiece to be forwarded to the address indicating the forwarding address indicator.

39. An system as defined in claim 38 wherein the processing means further comprises a reason-for-return notification means responsive to the return-to-sender addressing means for instructing the mailpiece labeler to label a mailpiece to be returned to sender with an indicator indicating the reason for the return selected from a list of different reasons for returning the mailpiece to the sender.

40. An system defined in claim 39 wherein the system further comprises reverse side imaging means for imaging a sender return address indicator positioned on a second side of each of the plurality of intermixed mailpieces and to interpose the image into the single-scan image of address and notification indicators positioned on the opposing side of each of the plurality of intermixed mailpieces as created by the mailpiece scanner so as to create a single data block image comprising receiver location address indicator, sender return address indicator, and sender notification indicator data.

41. An system as defined in claim 40 wherein the reverse side imaging means includes mirroring means positioned adjacent the mailpiece transporter for reflecting mirror images of return address indicators positioned on the second side of each corresponding mailpiece to the mailpiece scanning means.

42. An system as defined in claim 41 wherein the processing means further comprises reverse image translating means for re-orienting the reflected mirror images so that the single-scan images correspond substantially to the return address indicators as each appears positioned on the mailpiece.

43. An system as defined in claim 31 further comprising no-forwarding processing means for notifying mailpiece senders whose non-deliverable mailpieces cannot be forwarded and cannot be returned to the senders.

44. An system as defined in claim 43 wherein the no-forwarding processing means further comprises exposed page imaging and labeling means for imaging the exposed page of a mailpiece having no sender return address indicator positioned thereon, labeling the image and storing the labeled image.

45. An system as defined in claim 44 wherein the no-forwarding processing means further comprises stored image comparison means for comparing each labeled image stored with a set of preselected images, each preselected image having a corresponding return address indicator, to thereby identify a match between the stored image and one of the preselected images and to instruct the mailpiece labeling means to label a separate mailpiece with the corresponding return address indicator.

46. A system as defined in claim 45 further comprising at least one remote site destination printer in communication with the process controller for printing indicia on a selected indicia carrier.

47. An system as defined in claim 46 further comprising off-line processing means for allowing a system user to enter data identifying the return address indicator for corresponding mailpieces for which there is no match between the mailpiece's corresponding stored image and one of the preselected images.

48. A method for unified forwarding of mail and notifying sender, the method comprising the steps of:
generating electronic images of receiver location address indicators and sender return address indicators positioned on each of a plurality of mailpieces;
determining a corresponding receiver forwarding address indicator by searching for a match between each receiver location address indicator and a corresponding receiver forwarding address indicator for each mailpiece by making an electronic comparison between the generated electronic image and a preselected set of corresponding forwarding address indicators;
searching for the presence of a sender notification indicator positioned on each mailpiece;
generating a forwarding address indicator on each mailpiece having a match between the receiver location address indicator and the receiver forwarding address indicator; and
generating and storing a sender notification for each of the plurality of mailpieces having positioned thereon a sender notification indicator, the sender notification including the receiver location address indicator, receiver forwarding address indicator, and sender return address indicator.

49. A method as defined in claim 48 wherein a unique indicator is positioned on a mailpiece not having a match between the receiver location address indicator and the receiver forwarding address indicator.

50. A method as defined in claim 49 further comprising the step of off-line processing wherein address indicator data is supplied manually for each mailpiece not having a match between the receiver location address indicator and the receiver forwarding address indicator, and wherein the address indicator is subsequently positioned on the corresponding mailpiece.

51. A method as defined in claim 50 further comprising the step of positioning the generated and stored sender notification on a separate mailpiece for each of the plurality of mailpieces having positioned thereon a sender notification indicator and routing said separate mailpiece to the sender return address indicator.

52. A method for unified forwarding of mail and notifying sender, the method comprising the steps of:
electronically scanning a plurality of mailpieces and generating a corresponding single-scan image of receiver location address indicator and sender return address indicators;
searching for a match between each receiver location address indicator and a corresponding receiver forwarding address indicator from among a set of preselected receiver forwarding address indicators; and
labeling each mailpiece for which a match is found between the receiver location address indicator and one said preselected receiver forwarding address indicator with a label formed by interposing the receiver forwarding address indicator onto the single-scan image.

53. A method as defined in claim 52 further comprising the step of saving each label having interposed thereon the receiver forwarding address indicator along with the receiver location address indicator and sender return address indicator and positioning the label on a separate mailpiece for routing to the sender return address.

54. A method of routing mail to be returned to sender and notifying sender of the reason for return, the method comprising the steps of:
scanning each of a plurality of mailpieces having receiver address location indicators and sender return address location indicators positioned thereon to generate a single-scan image of the address indicators data;
separating the receiver location address indicator data;
electronically comparing the address indicator characters with a preselected list to determine a match from a preselected set of return indicators, each return indicator having an indicator of the reason the corresponding mailpiece was not deliverable; and
generating a corresponding a label positioned on a mailpiece and comprising the receiver location address indicator, the sender return address indicator, and corresponding indicator of the reason the mailpiece was not deliverable.

55. A method as defined in claim 54 further comprising the step of off-line processing of mailpieces for which not match is made, the processing including entering an indicator for failure to deliver the mail and saving the address indicators and the failure indicator for subsequent electronic processing of mailpieces to be returned to sender.
